(19) United States
(12) Patent Application Publication
(10) Pub. No.: US 2025/0147247 A1
(43) Pub. Date: May 8, 2025

(54) OPTICAL COUPLING STRUCTURE AND MANUFACTURING METHOD THEREFOR

(71) Applicant: ENKRIS SEMICONDUCTOR, INC., Suzhou (CN)

(72) Inventor: Kai CHENG, Suzhou (CN)

(73) Assignee: ENKRIS SEMICONDUCTOR, INC., Suzhou (CN)

(21) Appl. No.: 18/664,851

(22) Filed: May 15, 2024

(30) Foreign Application Priority Data
Nov. 7, 2023 (CN) 202311473532.2

(51) Int. Cl. G02B 6/42

(52) U.S. Cl. CPC G02B 6/4215; G02B 6/4239; G02B 6/4244; G02B 6/4249

(57) ABSTRACT

Disclosed are an optical coupling structure and a manufacturing method therefor. The optical coupling structure includes a first substrate, a plurality of light-source arrays disposed on a side of the first substrate, a second substrate, and a filtering layer disposed on a side of the second substrate. The first substrate is provided with a first through-hole penetrating through the first substrate, the first through-hole serves as a channel region and is preliminarily used for collecting optical signal emitted by each of the plurality of light-source array. The first substrate is disposed directly opposite to the filtering layer, the filtering layer is configured to filter light signals from different channel regions to reduce crosstalk of different wavelengths between adjacent channels. The second substrate is provided with a second through-hole to accommodate an end of an optical fiber, so that filtered optical signal may be transmitted to the fiber more accurately.

### CROSS-REFERENCE TO RELATED APPLICATIONS

This application claims priority to Chinese Patent Application No. 202311473532.2, filed on Nov. 7, 2023, which is hereby incorporated by reference in its entirety.

### TECHNICAL FIELD

Embodiments of the present application relate to the field of optical communication technologies, and in particular, to an optical coupling structure and a manufacturing method therefor.

### BACKGROUND

High-speed data exchange is one of bottlenecks in improving computility of devices such as data centers, high-performance computers, and large capacity storage. Short-distance optical fiber communication is one of the best solutions. The short-distance optical fiber communication typically consists of optoelectronic devices and fibers. A semiconductor laser is generally used as a light source for the optoelectronic devices, such as Vertical Cavity Surface Emitting Lasers (VCSEL) or Distributed Feedback Lasers (DFB) with edge emission. The semiconductor lasers require a current above a threshold value to function properly, resulting in a relatively high power consumption and reliability risks under high temperature conditions. In contrast, a Micro LED (Light-Emitting Diode) as light sources has advantages of light emission under spontaneous emission, a small size, a low power consumption, and a longer lifespan under high temperature conditions.

### SUMMARY

In view of this, embodiments of the present disclosure provide an optical coupling structure and a manufacturing method therefor, to solve a technical problem of high optical signal crosstalk in the related art.

According to a first aspect of the present disclosure, an embodiment of the present disclosure provides an optical coupling structure. The optical coupling structure includes: a first substrate and a plurality of light-source arrays disposed on a side of the first substrate, where the first substrate is provided with a first through-hole corresponding to at least one of the plurality of light-source arrays, and the first through-hole penetrates through the first substrate; and a second substrate and a filtering layer disposed on a side of the second substrate, where the first substrate is disposed directly opposite to the filtering layer, and the second substrate is provided with a second through-hole corresponding to at least one of the plurality of light-source arrays, the second through-hole penetrates through the second substrate, and the second through-hole is configured to accommodate an end of an optical fiber.

In an embodiment, the filtering layer is a photonic crystal.

In an embodiment, the photonic crystal includes a plurality of gaps disposed at intervals, and a size, in a direction parallel to a plane of the first substrate, of the gap ranges from 100 nm to 1000 nm.

In an embodiment, a distance between adjacent gaps ranges from 100 nm to 1000 nm.

In an embodiment, the distance between adjacent gaps and the size of the gap are positively correlated to a wavelength of the corresponding light-source array.

In an embodiment, a shape, in the direction parallel to the plane of the first substrate, of the gap includes at least one of a circle, an ellipse, and a polygon.

In an embodiment, a depth, in a direction perpendicular to the plane of the first substrate, of the gap ranges from 100 nm to 500 nm.

In an embodiment, a material of the photonic crystal includes at least one of monocrystalline silicon, polycrystalline silicon, SiO2, SiN, and supramolecular polymer.

In an embodiment, the filtering layer is located inside the first through-hole.

In an embodiment, a size of the first through-hole is less than or equal to a size of the second through-hole in the direction parallel to the plane of the first substrate.

In an embodiment, the size of the first through-hole or the size of the second through-hole ranges from 10 μm to 250 μm in the direction parallel to the plane of the first substrate.

In an embodiment, each of the plurality of light-source arrays includes at least one light-emitting unit, and a light-emitting wavelength of the light-emitting unit ranges from 360 nm to 1600 nm.

In an embodiment, each of the plurality of light-source arrays includes a light-emitting unit, and a difference value between wavelengths of adjacent light-emitting units ranges from 10 nm to 100 nm.

In an embodiment, each of the light-source array includes a plurality of light-emitting units, and a difference value between wavelengths of adjacent light-emitting units in a same light-source array ranges from 10 nm to 100 nm.

In an embodiment, a size, in the direction parallel to the plane of the first substrate, of the light-emitting unit ranges from 5 μm to 200 μm.

In an embodiment, the light-source array includes any one of a Light-Emitting Diode (LED), a Micro Light-Emitting Diode (micro LED), a Mini Light-Emitting Diode (Mini LED), a Vertical Cavity Surface Emitting Laser (VCSEL), and a Resonant Cavity Light-Emitting Diode (RCLED).

In an embodiment, a nucleation layer and/or a buffer layer are further provided between the light-source array and the first substrate.

According to another aspect of the present disclosure, an embodiment of the present disclosure provides a manufacturing method for an optical coupling structure. The manufacturing method includes: preparing a plurality of light-source arrays on a side of a first substrate; etching, at a position corresponding to at least one of the plurality of light-source arrays, the first substrate to form a first through-hole penetrating through the first substrate; preparing a filtering layer on a side of a second substrate; etching the second substrate to form a second through-hole penetrating through the second substrate; and aligning the first substrate with the filtering layer and bonding the first substrate and the filtering layer, so that at least one of the plurality of light-source arrays corresponds to the second through-hole, where the second through-hole is configured to accommodate an end of an optical fiber.

In an embodiment, the filtering layer is a graphical structure, and the bonding the first substrate with the filtering layer includes: making the graphical structure of the filtering layer corresponding to the first through-hole of the first substrate and bonding the first substrate with the filtering layer, where the filtering layer is located inside the first through-hole after bonding.

In an embodiment, the preparing a plurality of light-source arrays on a side of a first substrate includes: epitaxially preparing the plurality of light-source arrays on the side of the first substrate; or transferring the plurality of light-source arrays to the side of the first substrate and bonding the plurality of light-source arrays with the first substrate.

### BRIEF DESCRIPTION OF THE DRAWINGS

FIG. 1 is a three-dimensional schematic structural diagram of an optical coupling structure according to an embodiment of the present disclosure.

FIG. 2 is a three-dimensional schematic structural diagram of a light-source structure according to an embodiment of the present disclosure.

FIG. 3 is a cross-sectional view of an optical coupling structure according to an embodiment of the present disclosure.

FIG. 4 is a schematic structural diagram of a filtering structure according to an embodiment of the present disclosure.

FIG. 5 is a three-dimensional schematic structural diagram of a filtering structure according to an embodiment of the present disclosure.

FIG. 6 is a cross-sectional view of another optical coupling structure according to an embodiment of the present disclosure.

FIG. 7 is a flowchart of a manufacturing method for an optical coupling structure according to an embodiment of the present disclosure.

FIGS. 8 to 12 are schematic diagrams of intermediate structures during a manufacturing process for an optical coupling structure according to an embodiment of the present disclosure.

FIG. 13 is a schematic structural diagram of another filtering structure according to an embodiment of the present disclosure.

FIG. 14 is a flowchart of another manufacturing method for an optical coupling structure according to another embodiment of the present disclosure.

FIG. 15 is a flowchart of another manufacturing method for an optical coupling structure according to still another embodiment of the present disclosure.

FIG. 16 is a flowchart of a manufacturing method for an optical coupling structure according to yet still another embodiment of the present disclosure.

### DETAILED DESCRIPTION OF THE EMBODIMENTS

A clear and complete description of technical solutions in embodiments of the present disclosure will be given below with reference to accompanying drawings of the embodiments of the present disclosure. Apparently, the described embodiments are only a part, but not all of the embodiments of the present disclosure.

A data transmission speed may be improved by increasing a quantity of signal channels or increasing a modulation bandwidth of a single signal channel. However, as the quantity of signal channels increases, signal crosstalk between different channels also increases.

To solve the problem mentioned above, the present disclosure provides an optical coupling structure and a manufacturing method therefor. The optical coupling structure includes a first substrate and a plurality of light-source arrays disposed on a side of the first substrate, where the first substrate is provided with a first through-hole corresponding to at least one of the plurality of light-source arrays, and the first through-hole penetrates through the first substrate; and a second substrate and a filtering layer disposed on a side of the second substrate, where the first substrate is disposed directly opposite to the filtering layer, and the second substrate is provided with a second through-hole corresponding to at least one of the plurality of light-source arrays, the second through-hole penetrates through the second substrate, and the second through-hole is configured to accommodate an end of an optical fiber.

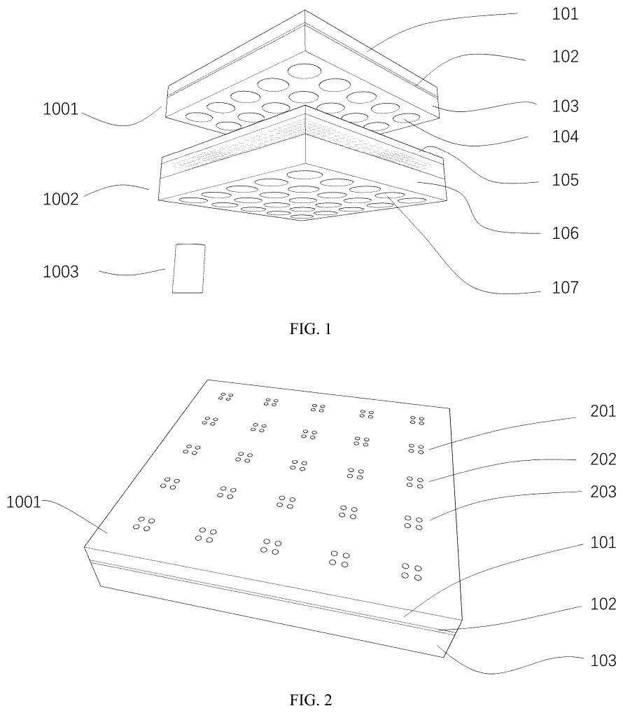

The optical coupling structure and the manufacturing method therefor provided by the present disclosure will be further explained with reference to FIGS. 1 to 12.

FIG. 1 is a three-dimensional schematic structural diagram of an optical coupling structure according to an embodiment of the present disclosure. As shown in FIG. 1, an optical coupling structure includes a first substrate 103 and a plurality of light-source arrays disposed on a side of the first substrate 103, where the first substrate is provided with a first through-hole 104 corresponding to at least one of the plurality of light-source arrays, and the first through-hole 104 penetrates through the first substrate 103; and a second substrate 106 and a filtering layer disposed on a side of the second substrate 106, where the first substrate 103 is disposed directly opposite to the filtering layer 105, and the second substrate 106 is provided with a second through-hole 107 corresponding to at least one of the plurality of light-source arrays, the second through-hole 107 penetrates through the second substrate 106, and the second through-hole 107 is configured to accommodate an end of an optical fiber 1003.

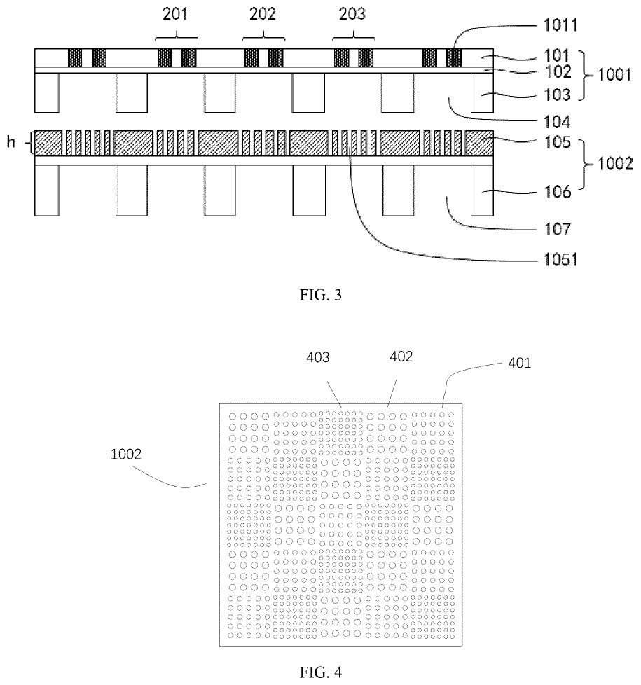

It should be noted that for clear illustration, 101 in FIG. 1 refers to a layer where the light-source array is located. FIG. 2 is a three-dimensional schematic structural diagram of a light-source structure according to an embodiment of the present disclosure. FIG. 3 is a cross-sectional view of an optical coupling structure according to an embodiment of the present disclosure. As shown in FIGS. 2 and 3, the layer 101 where the light-source array is located includes a plurality of light-source arrays 201/202/203. Each of the plurality of light-source arrays, for example, the light-source array 201, corresponds to the first through-hole 104. Unless otherwise specified, in the following, 201 will be used to refer to the light-source array.

Specifically, as shown in FIG. 1 and FIG. 3, a light-source structure 1001 is formed by the first substrate 103 and the plurality of light-source arrays 201 disposed on a side of the first substrate 103, and a filtering structure 1002 is formed by the second substrate 106 and the filtering layer 105 disposed on a side of the second substrate 106.

It should be noted that FIG. 1 and FIG. 3 are three-dimensional schematic structural diagrams of the optical coupling structure before bonding of the light-source structure 1001 and the filtering structure 1002.

Specifically, as shown in FIGS. 1 and 3, the first through-hole 104 corresponding to each of the plurality of light-source arrays 201 is provided in the light-source structure 1001, penetrating through the first substrate 103. The first through-hole 104 serves as a channel region for transmitting a optical signal from the light-source array 201 to the filtering structure 1002, and may be preliminarily used for collecting optical signal. In the filtering structure 1002, the first substrate 103 of the light-source structure 1001 is disposed directly opposite to the filtering layer 105 of the filtering structure 1002. The optical signal enters the filtering layer 105 through the first through-hole 104. The filtering layer 105 is configured to filter the optical signal of different channel regions to reduce crosstalk between signals of different wavelengths from adjacent channels, so that the optical signal entering the fiber 1003 through the second through-hole 107 may be more accurate.

Optionally, the first substrate 103 serves as an epitaxial substrate of the light-source array 201. A nucleation layer, a buffer layer, and other film layer 102 may be provided between the light-source array 201 and the first substrate 103. The first through-hole 104 is formed by etching on the side, away from the light-source array 201, of the first substrate 103 to avoid substrate peeling process.

Optionally, the light-source array 201 may be transferred to the side of the first substrate 103 and bonded with the side of the first substrate 103. In this optical coupling structure, there may be no film layer 102 between the light-source array 201 and the first substrate 103.

In an embodiment, as shown in FIG. 3, the filtering layer 105 is a photonic crystal. Specifically, waves of a certain frequency range are allowed selectively to enter the photonic crystal. When the optical signal reaches the photonic crystal, an optical signal in a target wavelength range may pass through the photonic crystal, and an optical signal in other wavelength ranges is filtered and removed. Therefore, the filtering layer 105 may be used to filter the optical signal of different channel regions to reduce crosstalk between signals of different wavelengths from adjacent channels.

In an embodiment, a size, in a direction parallel to a plane of the first substrate, of a gap 1051 ranges from 100 nm to 1000 nm. Specifically, the optical signal is filtered by the photonic crystal through the gap 1051 and a material between adjacent gaps 1051. The size of the gap 1051 ranges from 100 nm to 1000 nm. A distance between two adjacent gaps 1051 ranges from 100 nm to 1000 nm, so that optical signals of wavelengths ranging from 360 nm to 1600 nm may be filtered.

In an embodiment, as shown in FIG. 3, the photonic crystal includes a plurality of gaps 1051 disposed at intervals, and a distance between adjacent gaps 1051 ranges from 100 nm to 1000 nm. Specifically, the smaller the distance between adjacent gaps is, the more difficult the manufacturing process is. The larger the distance between adjacent gaps is, the poorer a filtering effect is. Therefore, it is more appropriate to make the distance between adjacent gaps range from 100 nm to 1000 nm, thereby improving the filtering effect and reducing the process difficulty.

In an embodiment, the distance between adjacent gaps 1051 and the size of the gap 1051 are positively correlated to a wavelength of the corresponding light-source array 201. It should be noted that, as shown in FIG. 3, corresponding to the position of the light-source array 201, the distance between adjacent gaps 1051 refers to a width, in the direction parallel to the plane of the first substrate 103, of a diagonal stripe filling pattern. The size of the gap 1051 refers to a distance between two adjacent diagonal stripe filling patterns. Specifically, to filter out a optical signal with longer wavelengths, the size of the gap 1051 and the distance between two adjacent gaps are configured to be relatively large. It should be noted that a correspondence relationship between two adjacent gaps 1051 and the light-source array 201 refers to that an optical signal from the light-source array 201 may be transmitted through the two adjacent gaps 1051. A correspondence relationship between the gap 1051 and the light-source array 201 refers to that the optical signal from the light-source array 201 may be transmitted through the gap 1051.

Optionally, FIG. 4 is a schematic structural diagram of a filtering structure according to an embodiment of the present disclosure, as shown in FIG. 4, the filtering structure 1002 includes filtering layers 401/402/403 with various gaps. For example, a gap of the filtering layer 403 is smaller than a gap of the filtering layer 401, and a wavelength of an optical signal filtered by the filtering layer 403 is smaller than a wavelength of an optical signal that filtered by the filtering layer 401.

In an embodiment, a shape, in the direction parallel to the plane of the first substrate 103, of the gap includes at least one of a circle, a ellipse, and a polygon. Specifically, as shown in FIG. 4, the shape of the gap is a circle. Optionally, the shape of the gap is triangular, hexagonal, and so on.

In an embodiment, a depth h, in a direction perpendicular to the plane of the first substrate 103, of the gap ranges from 100 nm to 500 nm. Specifically, the smaller the depth h is, the poorer the filtering effect is. And the larger the depth h is, the more difficult the manufacturing process is. Therefore, it is more appropriate to make the depth h range from 100 nm to 500 nm, thereby improving the filtering effect and reducing the process difficulty.

Optionally, the depth h of the gap is the same as a thickness of the filtering layer 105. Optionally, the gap falls to penetrate through the filtering layer 105.

In an embodiment, a material of the photonic crystal includes any one of monocrystalline silicon, polycrystalline silicon, SiO₂, SiN, and supramolecular polymer. Optionally, FIG. 5 is a three-dimensional schematic structural diagram of a filtering structure according to an embodiment of the present disclosure, as shown in FIG. 5, a material of the filtering structure 1002 is silicon on insulator (SOI), and the silicon layers on both sides of a SiO₂ layer 404 are respectively configured to be the second substrate 106 and to be prepared as the filtering layer 105. The filtering layer 105 includes multiple photonic crystals 401/402/403 with various gap sizes and are configured to filter optical signals in various wavelength ranges.

Optionally, as shown in FIG. 3, the photonic crystal is only provided in a region, corresponding to the first through-hole 104 or the second through-hole 107, of the filtering layer 105. Optionally, as shown in FIG. 5, the photonic crystal is provided in an entire region of the filtering layer 105.

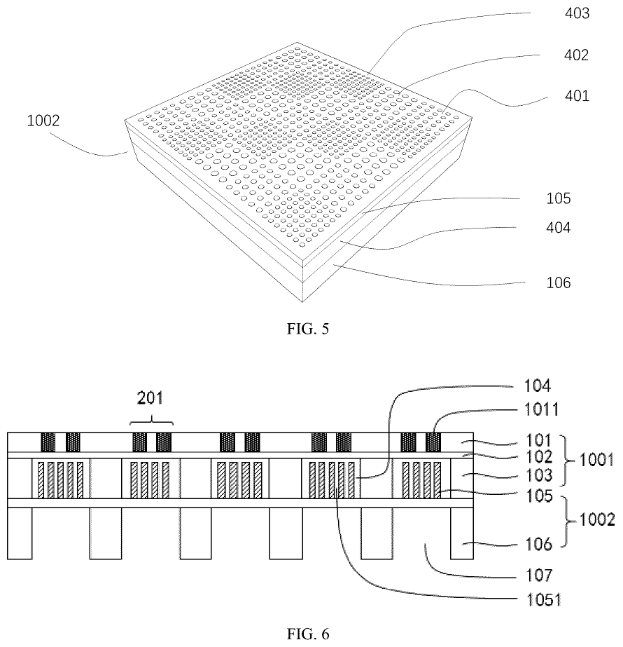

In an embodiment, FIG. 6 is a cross-sectional view of another optical coupling structure according to an embodiment of the present disclosure. As shown in FIG. 6, the filtering layer 105 is located inside the first through-hole 104 to reduce an overall thickness of the optical coupling structure, thereby reducing the size of the optical communication structure.

Optionally, during the manufacturing process of the first through-hole 104, the filtering layer 105 of the photonic crystal structure is synchronously etched at one step, so that the filtering layer 105 is located inside the first through-hole 104. At this time, the thickness, in the direction perpendicular to the plane of the first substrate 103, of the filtering layer 105 is equal to the depth of the first through-hole 104. Optionally, the first through-hole 104 is first made on the light-source structure 1001, and then the filtering layer 105 matching with the shape of the first through-hole 104 is manufactured, so that the filtering layer 105 is located inside the first through-hole 104 while bonding the light-source structure 1001 with the filtering structure 1002. Meanwhile, it should be noted that the thickness, in the direction perpendicular to the plane of the first substrate 103, of the filtering layer 105 is less than the depth of the first through-hole 104 to avoid the filtering layer 105 from affecting the light-emitting surface due to contact with the light-source structure 1001.

It should be noted that FIG. 6 is a three-dimensional schematic structural diagram of the optical coupling structure after the bonding between the light-source structure 1001 and the filtering structure 1002.

In an embodiment, in the direction parallel to the plane of the first substrate 103, a size of the first through-hole 104 is less than or equal to a size of the second through-hole 107. Optionally, as shown in FIG. 3, the size of the first through-hole 104 is equal to the size of the second through-hole 107. As shown in FIG. 6, the size of the first through-hole 104 is less than the size of the second through-hole 107. Specifically, when two sizes of the first through-hole 104 and the second through-hole 107 are the same, a same lithography process may be used to manufacture the first through-hole 104 and the second through-hole 107 to reduce process difficulty. When the size of the second through-hole 107 is larger than the size of the first through-hole 104, it may be ensured that all optical signals passing through the filtering layer 105 may enter the second through-hole 107.

In an embodiment, as shown in FIG. 3, each of the plurality of light-source array 201 includes at least one light-emitting unit 1011. Light-emitting wavelengths of the light-emitting unit 1011 ranges from 360 nm to 1600 nm. Specifically, the light-emitting wavelength range of the light-emitting unit 1011 covers both visible and near-infrared spectra.

Optionally, the light-source array includes any one of a Light-Emitting Diode (LED), a Micro LED, a Mini LED, a Vertical Cavity Surface Emitting Laser (VCSEL), and a Resonant Cavity Light-Emitting Diode (RCLED).

Optionally, for example, when the light-source array is the Micro LED and GaN based semiconductor materials is used to form the light-emitting unit 1011, in the direction perpendicular to the plane of the first substrate 103, a film layer 102 including an AlN nucleation layer and a GaN buffer layer, and the light-emitting unit 1011 are sequentially located on the first substrate 103. The light-emitting unit 1011 includes an N-type GaN layer, an active layer and a P-type GaN layer. The active layer is a combination of any two of GaN, InGaN, AlGaN, and InAlGaN, and a light-emitting wavelength range of the active layer is within the visible light wavelength range. Optionally, a material of the first substrate 103 includes any one of Si, SiC, GaN, sapphire, and AlN.

Optionally, for example, when the light-source array is the VCSEL, the material of the first substrate 103 is GaAs, and the light-emitting unit 1011 above the first substrate 103 includes an N-type GaAs layer, an active layer, and a P-type GaAs layer. The active layer is a combination of any two of GaAs, InGaAs, AlGaAs, and InAlGaAs, and the light-emitting wavelength of the active layer is around 850 nm.

In an embodiment, each of the plurality of light-source arrays 201 includes a light-emitting unit 1011. A difference value between light-emitting wavelengths of adjacent light-emitting units 1011 ranges from 10 nm to 100 nm. Specifically, when the difference value between light-emitting wavelengths of adjacent light-emitting units 1011 is relatively small, it is difficult to distinguish optical signals with smaller wavelength differences by adjacent filter structures. When the difference value between light-emitting wavelengths of adjacent light-emitting units 1011 is relatively large, a quantity of signal channels is reduced at an effective area. Therefore, it is appropriate to make the difference value between light-emitting wavelengths of adjacent light-emitting units 1011 range from 10 nm to 100 nm, thereby improving the filtering effect and increasing the quantity of signal channels. Specifically, a light-source array 201 includes a light-emitting unit 1011 and corresponds to an optical fiber. Therefore, an optical fiber transmits an optical signal of a single wavelength.

In an embodiment, each of the plurality of light-source array 201 includes a plurality of light-emitting units 1011. A difference value between light-emitting wavelengths of adjacent light-emitting units 1011 ranges from 10 nm to 100 nm. Specifically, a light-source array 201 includes a plurality of light-emitting units 1011, and the light-source array 201 corresponds to an optical fiber. Therefore, optical signals of multiple wavelengths may be transmitted by the optical fiber.

In an embodiment, a size, in the direction parallel to the plane of the first substrate 103, of the light-emitting unit 1011 ranges from 5 μm to 200 μm. Optionally, when the light-source array 201 includes a light-emitting unit 1011, the size of the light-emitting unit 1011 may tend towards 200 μm. Optionally, when the light-source array 201 includes a plurality of light-emitting units 1011, a plurality of small-sized light-emitting units 1011 may be selected according to actual needs to form the =light-source array 201.

In an embodiment, in the direction parallel to the plane of the first substrate 103, a size of the first through-hole 104 or a size of the second through-hole 107 ranges from 10 μm to 250 μm. Specifically, a position and the size of the first through-hole 104 correspond to a position and the size of the light-source array 201. Alternatively, a position and the size of the second through-hole 107 correspond to the position and the size of the light-source array 201. Optionally, in the direction parallel to the plane of the first substrate 103, a cross-sectional shape of the first through-hole 104 or the second through-hole 107 is circular, and the sizes of the two through-holes refer to diameters of the circle. Alternatively, the cross-sectional shape of the first through-hole 104 or the second through-hole 107 is polygonal, and the sizes of the two through-holes refer to side lengths of the polygon.

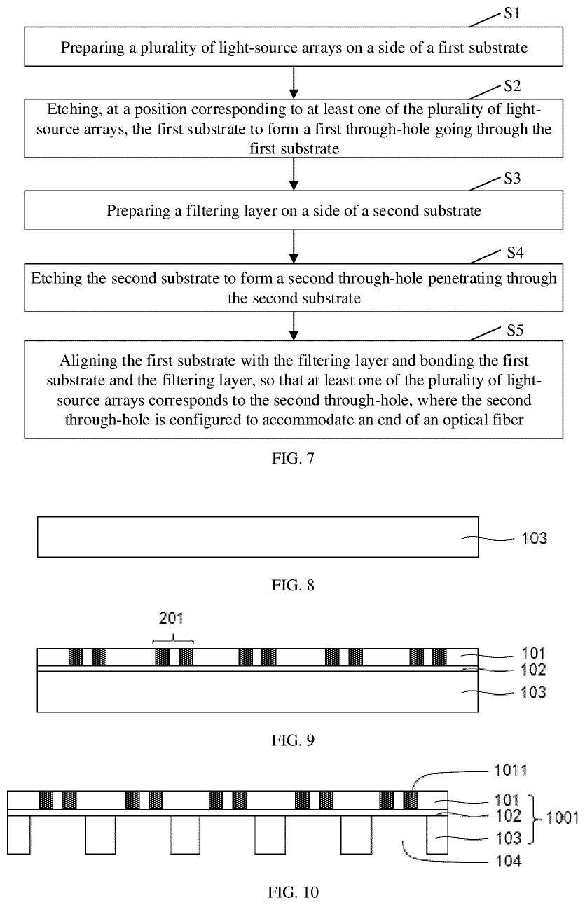

In an embodiment, in an optical coupling structure, the plurality of light-source arrays may be arranged in 1×N, N×N, or N×M, where N and M represent positive integers. An embodiment of the present disclosure further provides a manufacturing method for an optical coupling structure. FIG. 7 is a flowchart of a manufacturing method for an optical coupling structure according to an embodiment of the present disclosure. FIGS. 8 to 12 are schematic diagrams of intermediate structures during a manufacturing process for an optical coupling structure according to an embodiment of the present disclosure. The manufacturing method includes the following steps.

Step S1: preparing a plurality of light-source arrays on a side of a first substrate. As shown in FIG. 8 and FIG. 9, a plurality of light-source arrays 201 are prepared on a side of the first substrate 103. Specifically, as shown in FIG. 9, if a GaN based material is used for epitaxial preparing of the light-source array, film layers 102 including a core layer and a buffer layer are first prepared on the first substrate 103, and then the light-source array 201 is prepared through mask process. Alternatively, after the film layer 102 is prepared, a light-emitting layer is epitaxially prepared as a whole surface, and then the light-source array 201 is formed through etching process. Optionally, the side of the first substrate 103 used for epitaxial preparing of the light-source array 201 is a patterned surface, so that the plurality of light-source arrays 201 arranged in an array may be manufactured epitaxially at one step (not shown).

Step S2: etching, at a position corresponding to at least one of the plurality of light-source arrays, the first substrate to form a first through-hole going through the first substrate. As shown in FIG. 10, the first substrate 103 is etched at a position corresponding to at least one of the light-source arrays 201 to form the first through-hole 104 penetrating through the first substrate 103. Then, a light-source structure 1001 is obtained. Specifically, the first substrate 103 and the plurality of light-source arrays 201 are inverted on a transposed substrate, and then the first substrate 103 is etched through wet or dry etching to form the first through-hole 104.

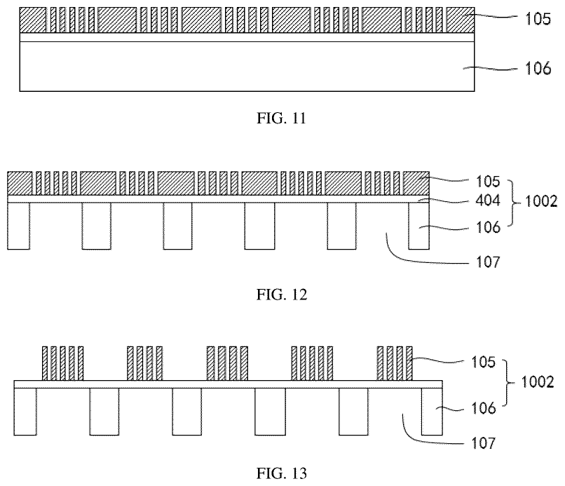

Step S3: preparing a filtering layer on a side of a second substrate. As shown in FIG. 11, the filtering layer 105 is prepared on a side of the second substrate 106. Specifically, the filtering layer 105 may be a photonic crystal, and the photonic crystal includes a gap.

Step S4: etching the second substrate to form a second through-hole penetrating through the second substrate. As shown in FIG. 12, the second substrate 106 is etched to form the second through-hole 107 penetrating through the second substrate. And then a filtering structure 1002 is obtained. Specifically, the second substrate 106 and the filtering layer 105 are inverted onto the transposed substrate, and then the second substrate 106 is etched through wet or dry etching to form the second through-hole 107. Optionally, the filtering structure 1002 is made of SOI (silicon on insulator) material, and silicon layers on both sides of a SiO₂ layer 404 are respectively configured to be the second substrate 106 and to be prepared as the filtering layer 105.

Step S5: aligning the first substrate with the filtering layer and bonding the first substrate and the filtering layer, so that at least one of the plurality of light-source arrays corresponds to the second through-hole, where the second through-hole is configured to accommodate an end of an optical fiber. As shown in FIG. 1, the first substrate 103 is directly opposite to the filtering layer 105. And then the first substrate 103 is bonded with the filtering layer 105, so that at least one of the plurality of light-source arrays 201 corresponds to the second through-hole 107. The second through-hole 107 is configured to accommodate an end of an optical fiber 1003. Specifically, the first substrate 103 is directly opposite to the filtering layer 105. And then the light-source structure 1001 is bonded with the filtering structure 1002 through wafer bonding. One end of the optical fiber 1003 is fixed in the second through-hole 107 by dispensing glue. Optionally, an end face of the optical fiber adopts an 8 degree angle structure or other optimized angles to reduce reflection.

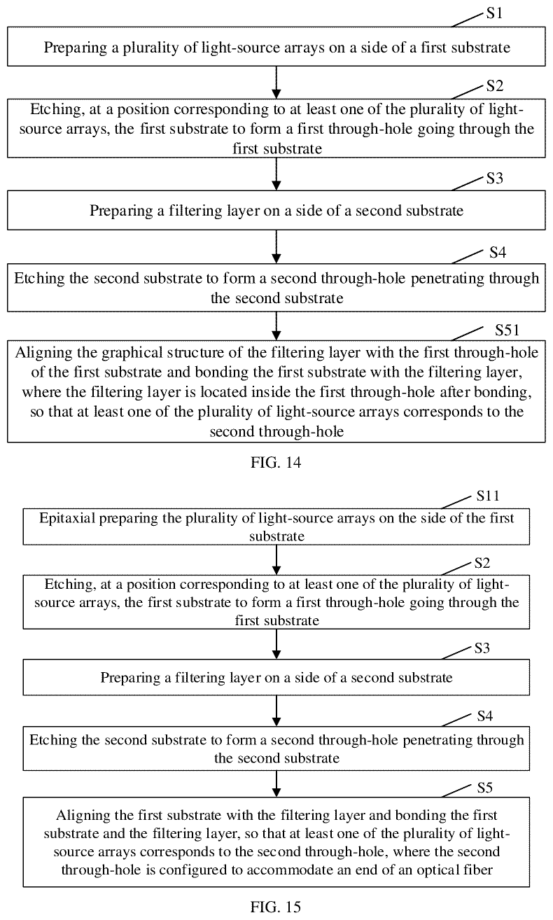

In an embodiment, FIG. 13 is a schematic structural diagram of another filtering structure according to an embodiment of the present disclosure. As shown in FIG. 10 and FIG. 13, the filtering layer is a graphical structure. As shown in FIG. 14, the aligning the first substrate with the filtering layer and bonding the first substrate and the filtering layer of Step S5 includes the following steps. Step S51: aligning the graphical structure of the filtering layer with the first through-hole of the first substrate and bonding the first substrate with the filtering layer. The filtering layer is located inside the first through-hole after bonding. Specifically, when the first substrate 103 is bonded to the filtering layer 105, the filtering layer 105 with the graphical structure corresponds to the first through-hole 104 of the first substrate 103. After the first substrate 103 is bonded to the filtering layer 105, the optical coupling structure as shown in FIG. 6 is formed, and the filtering layer 105 is located inside the first through-hole 104.

FIG. 15 is a flowchart of another manufacturing method for an optical coupling structure according to another embodiment of the present disclosure. As shown in FIG. 15, the Step S1 further includes the following steps. Step S11: epitaxial preparing the plurality of light-source arrays on the side of the first substrate. In an embodiment, as shown in FIG. 9, Step S1 of preparing a plurality of light-source arrays 201 on a side of the first substrate 103 includes: epitaxial preparing the plurality of light-source arrays 201 on the side of the first substrate 103. Specifically, a material of the first substrate 103 may be a substrate material that may be used for epitaxy, and the light-source array 201 is directly epitaxially prepared on the side of the first substrate 103. For example, a material of the light-source array 201 may be GaN based materials, and the material of the first substrate 103 is Si, AlN, or GaN.

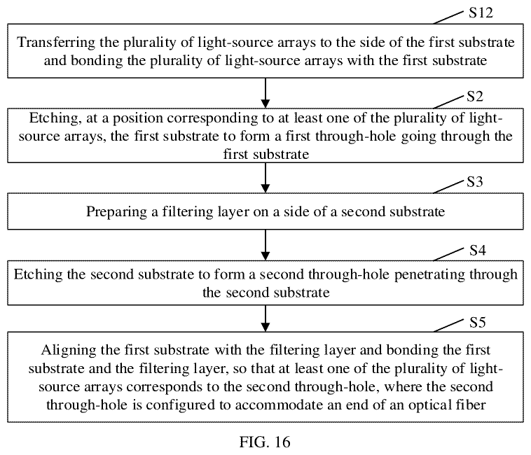

Alternatively, FIG. 16 is a flowchart of a manufacturing method for an optical coupling structure according to still another embodiment of the present disclosure. As shown in FIG. 16, the Step S1 further includes the following steps. Step S12: transferring the plurality of light-source arrays to the side of the first substrate and bonding the plurality of light-source arrays with the first substrate. Exemplarily, Step S1 of preparing the plurality of light-source arrays 201 on a side of the first substrate 103 includes: transferring the plurality of light-source arrays 201 to the side of the first substrate 103 and bonding the plurality of light-source arrays 201 with the first substrate 103. Specifically, the plurality of light-source array 201 are first prepared on other substrate, then the plurality of light-source array 201 are inverted and bonded onto the first substrate 103.

The present disclosure provides an optical coupling structure and a manufacturing method therefor. The optical coupling structure includes a first substrate and a plurality of light-source arrays disposed on a side of the first substrate, where the first substrate is provided with a first through-hole corresponding to at least one of the plurality of light-source arrays, and the first through-hole penetrates through the first substrate, the first through-hole serves as a channel region and is preliminarily used for collecting optical signal emitted by each of the plurality of light-source arrays; and a second substrate and a filtering layer disposed on a side of the second substrate, where the first substrate is disposed directly opposite to the filtering layer, the filtering layer is configured to filter light signals from different channel regions to reduce crosstalk of different wavelengths between adjacent channels; and the second substrate is provided with a second through-hole corresponding to at least one of the plurality of light-source arrays, the second through-hole penetrates through the second substrate, and is configured to accommodate an end of an optical fiber, so that filtered optical signal may be transmitted to the fiber more accurately.

It should be understood that the term “including” and its variations used in the present disclosure are open-ended, that is, “including but not limited to”. The term “one embodiment” means “at least one embodiment”, the term “another embodiment” means “at least one other embodiment”. In this specification, the schematic expressions of the above terms do not necessarily refer to the same embodiments or examples. Moreover, the specific features, structures, materials, or characteristics described can be combined in an appropriate manner in any one or more embodiments or examples. In addition, those skilled in the art may combine and permutation the different embodiments or examples described in this specification, as well as the features of different embodiments or examples, without contradiction.

What is claimed is:

1. An optical coupling structure, comprising:
a first substrate and a plurality of light-source arrays disposed on a side of the first substrate, wherein the first substrate is provided with a first through-hole corresponding to at least one of the plurality of light-source arrays, and the first through-hole penetrates through the first substrate; and
a second substrate and a filtering layer disposed on a side of the second substrate, wherein the first substrate is disposed directly opposite to the filtering layer, and the second substrate is provided with a second through-hole corresponding to at least one of the plurality of light-source arrays, the second through-hole penetrates through the second substrate, and the second through-hole is configured to accommodate an end of an optical fiber.

2. The optical coupling structure according to claim 1, wherein the filtering layer is a photonic crystal.

3. The optical coupling structure according to claim 2, wherein the photonic crystal comprises a plurality of gaps disposed at intervals, and a size, in a direction parallel to a plane of the first substrate, of the gap ranges from 100 nm to 1000 nm.

4. The optical coupling structure according to claim 3, wherein a distance between adjacent gaps ranges from 100 nm to 1000 nm.

5. The optical coupling structure according to claim 4, wherein the distance between adjacent gaps and the size of the gap are positively correlated to a wavelength of the corresponding light-source array.

6. The optical coupling structure according to claim 3, wherein a shape, in the direction parallel to the plane of the first substrate, of the gap comprises at least one of a circle, an ellipse, and a polygon.

7. The optical coupling structure according to claim 3, wherein a depth, in a direction perpendicular to the plane of the first substrate, of the gap ranges from 100 nm to 500 nm.

8. The optical coupling structure according to claim 2, wherein a material of the photonic crystal comprises at least one of monocrystalline silicon, polycrystalline silicon, SiO2, SiN, and supramolecular polymer.

9. The optical coupling structure according to claim 1, wherein the filtering layer is located inside the first through-hole.

10. The optical coupling structure according to claim 1, wherein a size of the first through-hole is less than or equal to a size of the second through-hole in the direction parallel to the plane of the first substrate.

11. The optical coupling structure according to claim 10, wherein the size of the first through-hole or the size of the second through-hole ranges from 10 μm to 250 μm in the direction parallel to the plane of the first substrate.

12. The optical coupling structure according to claim 1, wherein each of the plurality of light-source arrays comprises at least one light-emitting unit, and a light-emitting wavelength of the light-emitting unit ranges from 360 nm to 1600 nm.

13. The optical coupling structure according to claim 12, wherein each of the plurality of light-source arrays comprises a light-emitting unit, and a difference value between wavelengths of adjacent light-emitting units ranges from 10 nm to 100 nm.

14. The optical coupling structure according to claim 12, wherein each of the light-source array comprises a plurality of light-emitting units, and a difference value between wavelengths of adjacent light-emitting units in a same light-source array ranges from 10 nm to 100 nm.

15. The optical coupling structure according to claim 12, wherein a size, in the direction parallel to the plane of the first substrate, of the light-emitting unit ranges from 5 μm to 200 μm.

16. The optical coupling structure according to claim 1, wherein the light-source array comprises any one of a Light-Emitting Diode, a Micro Light-Emitting Diode, a Mini Light-Emitting Diode, a Vertical Cavity Surface Emitting Laser, and a Resonant Cavity Light-Emitting Diode.

17. The optical coupling structure according to claim 1, wherein a nucleation layer and/or a buffer layer are further provided between the light-source array and the first substrate.

18. A manufacturing method for an optical coupling structure, comprising:
preparing a plurality of light-source arrays on a side of a first substrate;
etching, at a position corresponding to at least one of the plurality of light-source arrays, the first substrate to form a first through-hole penetrating through the first substrate;
preparing a filtering layer on a side of a second substrate;
etching the second substrate to form a second through-hole penetrating through the second substrate; and
aligning the first substrate with the filtering layer and bonding the first substrate and the filtering layer, so that at least one of the plurality of light-source arrays corresponds to the second through-hole, wherein the second through-hole is configured to accommodate an end of an optical fiber.

19. The manufacturing method for the optical coupling structure according to claim 18, wherein the filtering layer is a graphical structure, and
the aligning the first substrate with the filtering layer and bonding the first substrate with the filtering layer comprises:
aligning the graphical structure of the filtering layer with the first through-hole of the first substrate and bonding the first substrate with the filtering layer, wherein the filtering layer is located inside the first through-hole after bonding.

20. The manufacturing method for the optical coupling structure according to claim 18, wherein the preparing a plurality of light-source arrays on a side of a first substrate comprises:
epitaxially preparing the plurality of light-source arrays on the side of the first substrate; or
transferring the plurality of light-source arrays to the side of the first substrate and bonding the plurality of light-source arrays with the first substrate.
